(19) United States
(12) Patent Application Publication
(10) Pub. No.: US 2018/0227724 A1
(43) Pub. Date: Aug. 9, 2018

(54) CHAIR, IN PARTICULAR OFFICE CHAIR, METHOD FOR CAPTURING MOVEMENT DATA OF A CHAIR, SYSTEM AND METHOD FOR EVALUATING MOVEMENT DATA OF A CHAIR AND COMPUTER PROGRAM FOR CARRYING OUT THE METHOD

(71) Applicant: BOCK 1 GMBH & CO. KG, Postbauer-Heng (DE)

(72) Inventor: HERMANN BOCK, PYRBAUM (DE)

(21) Appl. No.: 15/887,039

(22) Filed: Feb. 2, 2018

(30) Foreign Application Priority Data
Feb. 4, 2017 (DE) 102017102208.2

(51) Int. Cl. H04W 4/38; A47C 3/18; A47C 3/30; G01G 19/52

(52) U.S. Cl. CPC H04W 4/38; G01G 19/52; A47C 3/30; A47C 3/18

(57) ABSTRACT

A chair, in particular an office chair, includes at least one sensor that is positionally independent with respect to the chair and configured to capture movement data of the chair, in order to capture and/or evaluate events during the service life of the chair. The movement data is suitable for identifying characteristic movement patterns of the entire chair. A method for capturing movement data of a chair, a system and a method for evaluating movement data of a chair and a computer program for carrying out the method, are also provided.

### CROSS-REFERENCE TO RELATED APPLICATION

This application claims the benefit, under 35 U.S.C. § 119, of German Patent Application DE 10 2017 102 208.2, filed Feb. 4, 2017; the prior application is herewith incorporated by reference in its entirety.

### BACKGROUND OF THE INVENTION

### Field of the Invention

The invention relates to a chair, in particular an office chair. The invention also relates to a method for capturing movement data of a chair, a system and a method for evaluating movement data of a chair and a computer program for carrying out the method.

The prior art has disclosed the use of certain sensors in office chairs. Thus, e.g. capacitive sensors, strain gauges, etc., are used to capture the load on the seating area. Other sensors serve to capture pivot angles of individual chair components with respect to one another. Those sensors are always coupled to certain chair components, i.e. assigned to the respective component, and require a very specific placement on the component for correct functionality. The data thus obtained are used, for example, to notify the user about a certain incorrect seating behavior or else to allow the user to undertake certain desired chair adjustments particularly easily.

### SUMMARY OF THE INVENTION

It is accordingly an object of the invention to provide a chair, in particular an office chair, a method for capturing movement data of a chair, a system and a method for evaluating movement data of a chair and a computer program for carrying out the method, which overcome the hereinafore-mentioned disadvantages of the heretofore-known chairs, methods, systems and programs of this general type and which allow events during the service life of the chair to be captured and/or evaluated.

With the foregoing and other objects in view there is provided, in accordance with the invention, a chair, in particular an office chair, which comprises a plurality of sensors that are positionally independent with respect to the chair and embodied to capture movement data of the chair, the movement data being suitable for identifying characteristic movement patterns of the entire chair.

The system according to the invention for evaluating movement data of a chair, in particular an office chair, comprises receiving or reading devices for receiving movement data of the chair captured by a number of sensors that are positionally independent with respect to the chair, the movement data being suitable for identifying characteristic movement patterns of the entire chair, and moreover data processing devices for evaluating the received data, in particular for the purposes of identifying vandalism and/or processing complaints with respect to the chair, and output devices for outputting a result of the data evaluation.

Advantageous embodiments of the invention are specified in the dependent claims. The advantages and configurations explained below in conjunction with the chair or the system apply analogously to the methods according to the invention for capturing and evaluating, and vice versa.

A core concept of the invention is that of making events during the service life of the chair, which are reflected in a characteristic movement pattern of the entire chair, capturable and of capturing them. In this case, a characteristic movement pattern is understood to mean a collection of data which corresponds to a predefined pattern, wherein the data are the captured movement data or data that are ascertained from the captured movement data or data that are ascertained by using the captured movement data. A characteristic movement pattern of the entire chair is understood to mean a pattern of the movement of the chair in the entirety thereof. Therefore, such a movement pattern always relates to the movement of more than one chair component. The movement pattern preferably relates to the interplay of all chair components.

To this end, the invention breaks away from the conventional approach of a mandatory specific assignment of a sensor to a certain chair component. Instead, a plurality of sensors are used that are positionally independent with respect to the chair. This is understood to mean sensors which are able to carry out positionally independent measurements, i.e. measurements having results which are not dependent on the position of the sensors with respect to the chair. In this context, the invention also breaks away from the use of conventional sensors. Preferably, use is made, instead, of at least one inertial measurement unit (IMU) which, briefly, is understood to mean a spatial combination of a plurality of inertial sensors, preferably an accelerometer and a gyroscope, as a result of which rotation (rotational angle) and translation (accelerations) are capturable (6-axis IMU). In the present case, such an inertial measurement unit is an example of a sensor for positionally independent measurements, which can be used particularly advantageously. The use of other suitable types of sensors is likewise possible.

Below, the terms “positionally independent sensor” and “inertial measurement unit (IMU)” are used partly synonymously, with the IMU merely being a preferred embodiment of a positionally independent sensor.

As a result of the special type of the sensor system used in this case, in particular the capture of acceleration data which was previously not carried out in office chairs, it is not only possible to capture movement data that could not be captured previously but it is also the case that the placement of the sensor in or at the chair is, in a particularly simple manner, no longer linked to a specific chair component. Instead, any mechanical connection of the IMU to a chair component is sufficient, wherein this chair component need not necessarily be a movable component of the chair within the meaning of a part of the chair mechanism. The specific configuration of the sensor in or at the chair does not influence the measurement result or, in any case, it only influences it in an insubstantial manner with respect to the movement patterns of the chair in the entirety thereof, which movement patterns can be sufficiently distinguished from one another and are obtainable from the movement data.

It is important for the invention that the sensor is securely installed on the chair. Expressed differently, a mobile sensor system, which is only provided for an intermittent, in particular detachable attachment to the chair, is unsuitable. Instead, a secure, preferably non-detachable connection between the sensor and the chair is necessary. With respect to the placement of the sensor, there are preferred and less preferred positions in or at the chair. For the purposes of obtaining measurement results that can be evaluated particularly well or measurement results that are particularly clear and unambiguous, a placement of the sensor obliquely in space, more precisely obliquely with respect to one or more axes of the chair coordinate system is preferably advantageous. Particularly when the focus is on capturing translations (acceleration values), a placement of the sensor on exactly one of these spatial axes may be disadvantageous for the same reasons. A corresponding statement applies within the scope of capturing the rotational angles if the sensor is placed on one of the axes of rotation of the chair.

The characteristic movement patterns which are identifiable by evaluating the movement data of the chair are, in particular and preferably, patterns for the following movements: the user getting up out of the chair, the user sitting down on the chair, the chair rotating to the right or to the left, the chair rolling along the floor, a rolling along the floor with a relatively strong initial acceleration (e.g. after a lateral push or kick), a triggering of the gas spring (height adjustment), swinging movements of the seat and/or of the backrest (across the longitudinal direction of the seat), a changing of the seat inclination, a changing of the backrest inclination (leaning against the backrest), the chair tipping over to one side, the chair falling to the floor from an elevated point. The identification of further movement patterns is possible and lies within the scope of the invention.

According to the invention, the chair-inherent sensor (IMU) supplies movement data for a receiver, which may be embodied either as a chair-inherent receiver or as an external receiver. Preferably, the received data is subsequently recorded, wherein, if necessary, the data are processed and/or there is a data selection prior to storing. It is particularly advantageous if the data are recorded in a chair-inherent data storage device. In this case, the data storage is preferably embodied in such a way that the stored data, when necessary, can be read easily and at any time with the aid of a suitable reader and/or with the aid of a suitable wireless and/or contacting data connection.

With the aid of the recorded data, it is not only possible to subsequently evaluate the seating behavior of the users of the chair. The recorded data may also include the entire chair history, wherein this should be understood to mean the movement history of the chair. According to the invention, the load on the chair is captured, wherein the received and processed data provide information about the chair, more precisely about how the chair was treated.

Thus, it is possible, for example, to ascertain how often the gas spring was triggered or how often the user sat down on the chair. However, on the basis of appropriate movement patterns, it is also possible to recognize whether, and how often, the chair fell over or was overturned, or whether the chair fell to the floor from a relatively great height, for example during transport, during unloading from a delivery van, etc.

The evaluation of the movement data thus obtained, preferably on the basis of characteristic movement patterns, preferably serves the purpose of identifying vandalism and/or processing complaints at the chair producer or dealer. In particular, it is possible to ascertain on the basis of the evaluated data whether certain damage to the chair can be traced back to proper handling and operating of the chair within the scope of usual use or else to improper handling or the like.

Optionally, the obtained movement data may also be used to provide information about the user, more precisely their seating behavior, in particular under health aspects and in view of improved seated ergonomics. Then, the data evaluation can be used to inform the chair user about, for example, an ideal chair adjustment to be undertaken manually. However, there may also be, on the basis of the results of the data evaluation, an autonomous adjustment of the chair with the aid of suitable chair-inherent adjusting devices (actuators) in conjunction with an appropriate actuation of the adjustment devices by control devices, which are provided with the evaluated data.

The employed inertial measurement unit may also be embodied as a 9-axis IMU and may have additional magnetic field sensors in addition to acceleration sensors and angular rate sensors. Furthermore, a GNSS sensor may also be integrated into the IMU for the purposes of determining the position. While a 6-axis or 9-axis IMU serves as a central sensor of the chair, it is possible to provide further sensors, e.g. temperature or pressure sensors, to collect additional information about the chair history. These further data are then preferably used together with the captured movement data in order to describe the load on the chair over its service life more precisely. Additional movement data of the chair may be obtained by using further inertial measurement units and those additional movement data may be processed for the desired purposes. In particular, it is possible to use a number of further IMUs for position-dependent, in particular chair-component-related measurements in addition to the at least one IMU which is provided for carrying out measurements that are positionally independent with respect to the chair. By way of example, such further IMUs may be attached to chair components of the chair mechanism that move during the operation of the chair, in particular to the spring elements, advantageously there for identifying the inclination of a spring element used to set a spring force, for example when adjusting the pivot resistance of the backrest of the chair.

Particularly under the aspect of using the obtained data for the purposes of identifying vandalism and/or processing complaints, the sensor and/or the further data-processing or data-storing components of the system according to the invention are preferably attached in or at the chair in such a way that the sensor or the aforementioned components are fastened in a tamperproof and/or vandalism-proof manner. Moreover, the sensor or the components themselves may also be trained for manipulation protection and/or vandalism protection with the aid of suitable measures.

Other features which are considered as characteristic for the invention are set forth in the appended claims.

Although the invention is illustrated and described herein as embodied in a chair, in particular an office chair, a method for capturing movement data of a chair, a system and a method for evaluating movement data of a chair and a computer program for carrying out the method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side-elevational view of an office chair;

FIG. 2 is a block diagram showing components of the chair;

FIG. 3 is a block diagram showing components of the system; and

FIGS. 4 to 13 are graphs showing different movement profiles.

### DETAILED DESCRIPTION OF THE INVENTION

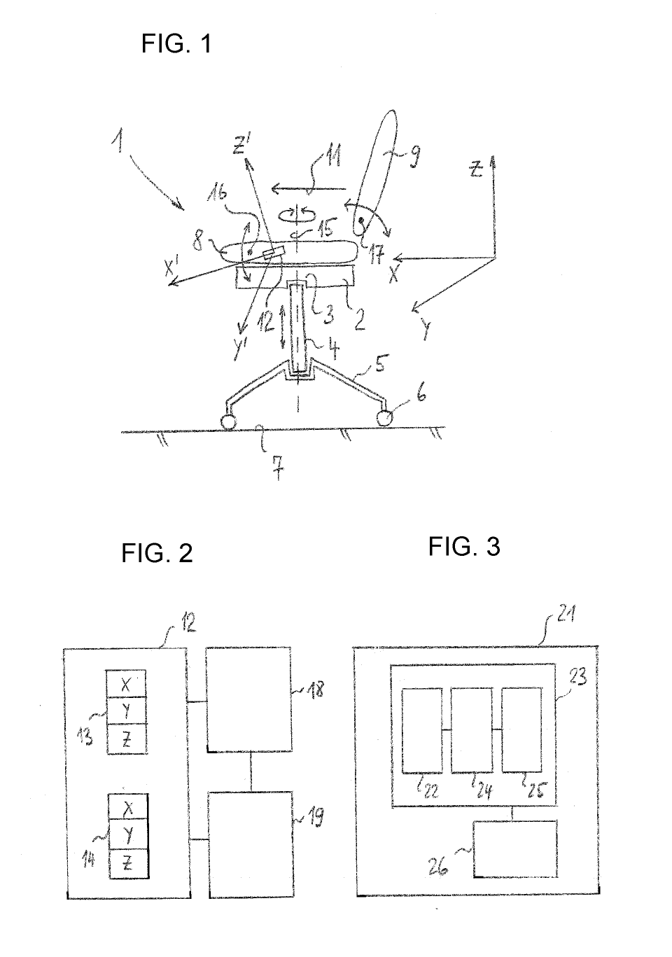

Referring now in detail to the figures of the drawings, which are diagrammatic, not true to scale, only include important constituent parts and use the same reference signs for elements with the same or comparable functions, and first, particularly, to FIG. 1 thereof, there is seen an exemplary office chair 1 which includes a base support 2 that can be placed onto a chair column 4 of the chair 1 by using a conical receiving device 3. The chair column 4 is equipped with a gas spring for adjusting the seat height and is connected to a foot cross 5 which, with the aid of rollers 6, facilitates the displacement of the chair 1 along the floor 7. The base support 2 is connected to a seat support 8 and a backrest support 9. Together, the base support 2, the seat support 8 and the backrest support 9 form a synchronizing mechanism which ensures mutually coupled kinematics that accompany a certain relative movement of seat and backrest with respect to one another. As a rule, a seat, provided with a cushioned seating area, of the office chair is assembled on the seat support 8. The backrest support 9 supports the backrest of the office chair 1. However, a different mechanism may be installed instead of such a synchronizing mechanism, for example a rocking mechanism, in which the backrest support 9 is rigidly connected to the seat support 8, the seat or the frame of the chair 1, and so the arising combination of the seat support 8 and the backrest support 9 is tiltable to the rear about a tilt axis extending across the longitudinal direction 11 of the chair when the user of the chair leans against the backrest. For the purpose of further considerations, a coordinate system of the chair 1 is set, with three mutually perpendicular coordinate axes being disposed as follows: the Z-axis is perpendicular to the floor 7 and lies on the vertical axis 15 of the chair column 4. The X-axis lies in the longitudinal direction 11 of the chair in a plane parallel to the floor 7 and points in the direction of the front edge of the seat. The Y-direction lies across the longitudinal direction 11 of the chair in the same plane as the X-axis. The origin of the coordinate system lies level with the seat cushion that has been pressed together under a load. For reasons of clarity, this chair coordinate system X, Y, Z has been depicted in a location displaced to the right in FIG. 1.

In a simple example illustrated herein, the chair 1 includes a single chair-inherent inertial measurement unit (IMU) 12. In view of the desired measurement results and the use thereof, the IMU is preferably not attached close to the floor, for instance in the region of the chair cross 5. Particularly if tilting or falling movements of the chair 1 should also be captured and evaluated, the IMU 12 is advantageously assembled at a sufficient distance from the floor 7. In the present case, the IMU 12 is integrated into the seat of the chair 1, more precisely lying in any oblique orientation in the seat support 8, i.e. not lying exactly on one of the X, Y and Z-axes of the chair coordinate system. This means that the IMU 12 does not lie on any of the three rotational or pivot axes of the chair 1. In particular, the IMU 12 does not lie on the vertical axis 15 of the chair column 4, which extends perpendicular to the floor 7 and which simultaneously constitutes the axis of rotation of the chair 1 for rotation to the left or right. The IMU 12 also does not lie on any of the two horizontal pivot axes of the chair that extend parallel to the floor 7, namely neither on a pivot axis 16 for inclining the seat nor on a pivot axis 17 for inclining the backrest, wherein these two pivot axes 16, 17 may be embodied at a distance from one another, as in the illustrated example, or may lie on top of one another. At the same time, the IMU 12 does not lie parallel to the Earth's magnetic field. Instead, the IMU 12 defines its own sensor coordinate system by way of its orientation in space, that sensor coordinate system having three mutually perpendicular coordinate axes X′, Y′ and Z′. The configuration of the IMU 12 in the seat of the chair 1, in particular in or at the seat support 8 of the chair 1, represents a particularly preferred embodiment variant of the invention, in particular under the aspect of a positioning of the sensor at a sufficient distance from the floor. The configuration of the sensor in or at the seat of the chair 1 is particularly advantageous in view of the movement data of the chair 1 that are important for identifying vandalism or for processing complaints. Neither a configuration of the sensor in the region of the chair cross 5 nor a configuration in or at the backrest or at the backrest support 9 facilitates the clear and unambiguous capture of such chair movement patterns which play a particularly important role for identifying vandalism or processing complaints.

The inertial measurement unit 12 is a 6-axis IMU 12 with three mutually orthogonal acceleration sensors 13 (translation sensors) for capturing the translational movement along the respective X′ and Y′ and Z′-axis and three angular rate sensors 14 (gyroscopic sensors) applied orthogonally with respect to one another, for capturing the rotational movements about the respective X′ and Y′ and Z′-axis. Instead of such a 6-axis IMU 12, use may also be made of a 9-axis IMU, which additionally contains a magnetometer having magnetic field sensors for capturing the magnetic field in the X′, Y′ and Z′-axis.

Consequently, the IMU 12 provides the following measurement values: accelerations 27 along the X′, Y′ and Z′-axis, captured by the acceleration sensors 13 of the IMU 12, specified in g (gravitational acceleration); angular speeds 28 about the X′, Y′ and Z′-axis, captured by the angular rate sensors 14 of the IMU 12, specified in °/s (degrees per second); angle of rotation 29 about the X′, Y′ and Z′-axis, calculated from the data of the angular rate sensors 14 of the IMU 12, specified in ° (degrees).

The sensors 13, 14 of the IMU 12 are attached to a suitable circuit board, on which circuits required for possible calculations may be provided at the same time (not depicted). The chair has chair-inherent storage devices for recording the movement data. To this end, use is made of suitable storage chips 18, which are connected to the sensors 13, 14 and advantageously likewise attached to the circuit board of the IMU 12. Instead of such an integrated construction of an IMU-data storage combination, provision may also, however, be made of a data storage that is attached separately from the IMU 12 in or at the chair 1.

The chair 1 moreover includes a chair-inherent data processing device 19 for processing the movement data prior to storage. Processing the data includes, for example, preprocessing that is advantageous in view of the subsequent use of the movement data and/or reducing the amount of data. Processing may also include a selection step in such a way that only selected but otherwise unprocessed data are stored. However, it is also possible to store selected processed data or else all data (processed or unprocessed). By way of example, the data processing device 19 is a suitable digital circuit which, advantageously, is combined with the storage device 18 and consequently also advantageously attached to the circuit board of the IMU 12 in such a way that an integrated IMU-data processing-data storage combination arises. However, provision may also be made of a data processing-data storage combination that is attached separately from the IMU in or at the chair 1.

Moreover, it is particularly advantageous that sensors 13, 14 and data storage 18 and data processing devices 19 can be used with a particularly low power consumption. By way of example, an employed IMU-data storage combination may be supplied with power over a time period of several years with the aid of a battery (not depicted) that is integrated into the chair 1 and that IMU-data storage combination may capture and record movement data in the process. Preferably, the invention serves to capture data during the entire service life of the chair 1.

The data captured and stored thus may subsequently be evaluated by using an evaluation system 21. In this case, use can be made of various evaluation systems, in particular also evaluation systems which serve to evaluate the movement data with respect to the user, in particular with respect to their seat posture, etc., or to inform the user with regard to ergonomic or health aspects.

The evaluation system 21 described herein serves to evaluate the captured data with respect to the chair 1, more precisely with respect to the load on the chair 1 or the chair history.

Accordingly, the system 21 includes a receiving or reading device 22, which is embodied to receive movement data of the chair 1, more precisely for receiving data stored by the storage device 18 of the chair 1, wherein these data may be the original measurement data (movement data) or else already selected and/or (pre-)processed data, i.e., for example, data that are based on the original movement data. By way of example, a data receiver that is connectable to the data storage 18 in a wireless or contacting manner, such as e.g. a computer 23 that can be linked to the chair 1 through a communication interface, may serve as a receiving or reading device 22.

The system 21 moreover includes a data processing device 24 that is embodied to evaluate the received data for the purposes of identifying vandalism and/or for processing complaints with respect to the chair 1. The data processing device 24 may be implemented as hardware or software in the process, for example in the form of a computer 23, equipped with a suitable computer program, having a computing unit 24 for executing the computer program. Evaluating the received data means the identification of characteristic movement patterns of the chair 1 in the entirety thereof, including the identification of shock events, in particular relating to the mechanical load on the chair 1, wherein this should be understood to mean, in particular, those movements of the chair 1 which are traced back to brief strong force effects.

The system 21 moreover has output devices 25, 26, which are embodied to output a result of the date evaluation. By way of example, these are data storage units 25 inherent to the computer 23 in order to realize an output in the form of data to be stored, and/or the a screen 26 of the computer 23 in order to implement a pictorial output.

The IMU 12, together with the storage device 18 and the data processing device 19 and, optionally, parts of the communication interface to the evaluation system 21, is fastened in the interior of the seat support 8 and/or provided with suitable devices in such a way that it cannot be manipulated, in particular cannot be removed or replaced. In a simple case, the IMU 12 may be installed in the seat support in such a way, for example in the style of an encapsulation, that a nondestructive removal of the IMU 12 is no longer possible. However, the selected protection devices against manipulation ensure the replaceability of the battery, where necessary. The securing measures preferably include a protection against access to the IMU 12 itself and the components attached to the circuit board of the IMU 12, preferably in the form of a combined receiving and fastening capsule (not depicted herein), in which the IMU 12 has been introduced with a secured access and which is connected to the seat support 8 in a non-detachable manner.

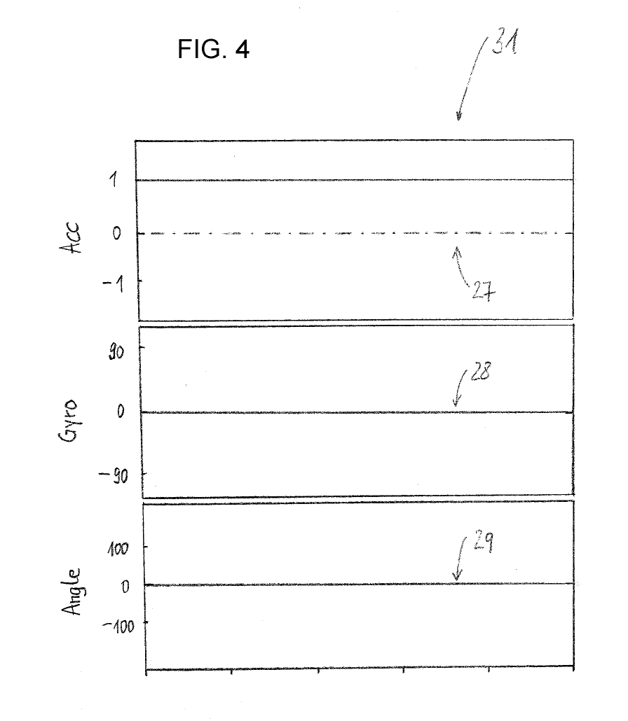

Exemplary movement profiles are described below with reference to FIGS. 4 to 13, the movement profiles emerging from the movement data captured with the IMU 12. The respective movement profiles are assembled on the basis of the captured or calculated data. For simplification purposes, the assumption is made in this case that, unlike what is depicted in FIG. 1, the IMU 12 is not disposed obliquely in the chair 1 but instead that the sensor coordinate system X′, Y′, Z′ of the IMU corresponds to the chair coordinate system X, Y, Z.

Each movement profile is composed of three measurement value categories, namely the acceleration values 27 (“Acc”) for the X, Y and Z-axis specified in the upper field, the values of the angular speed 28 (“Gyro”) for the X, Y and Z-axis specified in the middle field and the angle values 29 (“Angle”) for the X, Y and Z-axis specified in the lower field. The measurement values are plotted over time, wherein a time interval of 5 s is illustrated in each case. In this case, the values for the X-axis are represented by a dotted line in each case, the values for the Y-axis are represented by a broken line in each case and the values for the Z-axis are represented by a solid line in each case.

A first movement profile 31 in FIG. 4 shows a process in which the user sits at a desk and the chair 1 is at rest (initial position of the chair, for example parallel to the table edge of the desk).

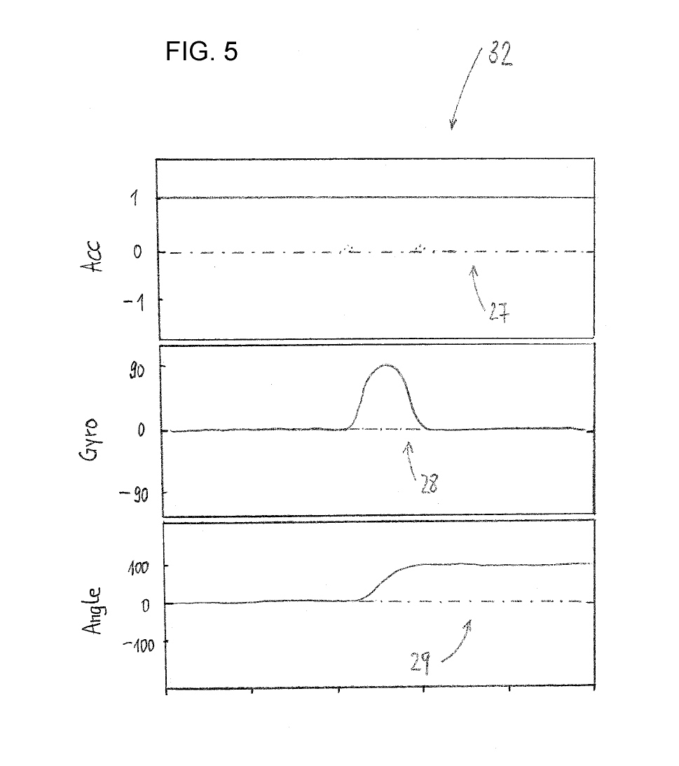

A second movement profile 32 in FIG. 5 shows a process in which the user sits at the desk and rotates the chair 1 by 100° to the right, for example in order to subsequently get up.

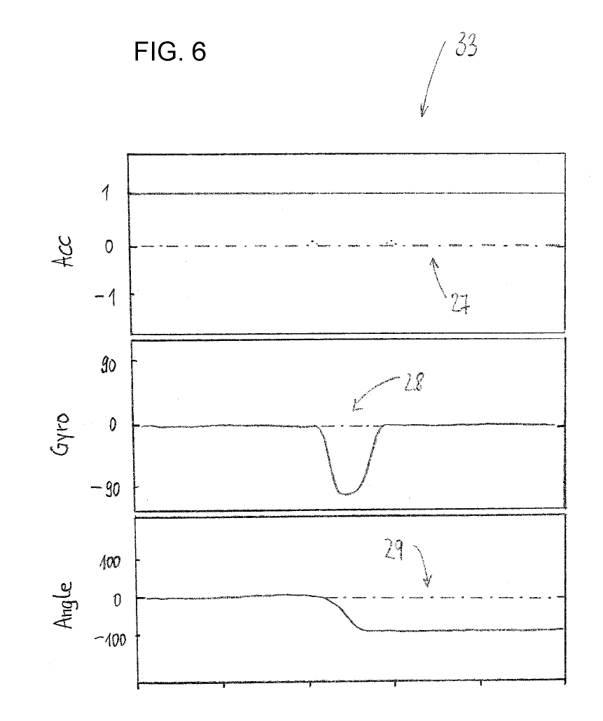

A third movement profile 33 in FIG. 6 shows a process in which the user sits at the desk and rotates the chair 1 by 95° to the left, for example in order to subsequently get up.

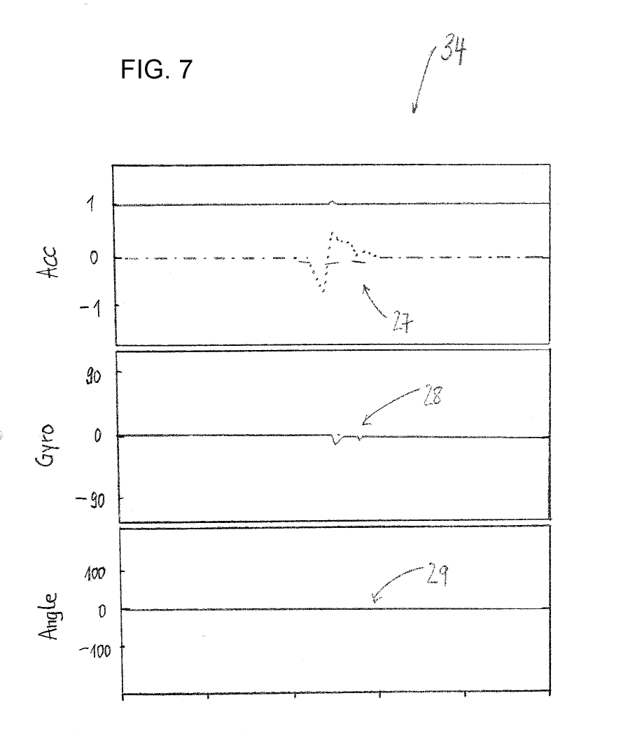

A fourth movement profile 34 in FIG. 7 shows a process in which the user rolls the chair backward by approximately 1 m in the longitudinal direction 11 of the chair, for example rolls the chair away from the desk in order to subsequently get up.

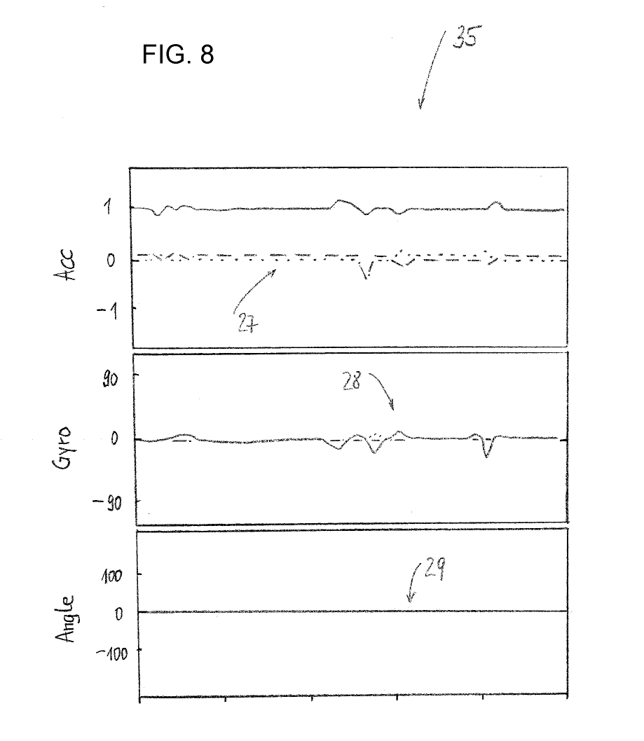

A fifth movement profile 35 in FIG. 8 shows a process in which the user triggers the height trigger multiple times and drives the seat up and down along the vertical axis 15, assisted by the gas spring.

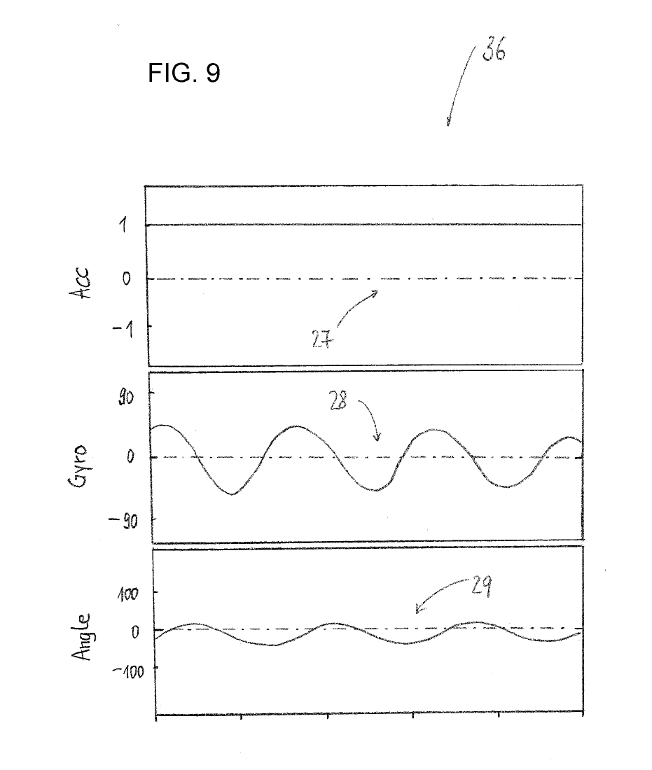

A sixth movement profile 36 in FIG. 9 shows a process in which the user, while seated on the chair 1, swings multiple times from left to right, i.e. across the longitudinal direction 11 of the chair, by approximately 50° in each case.

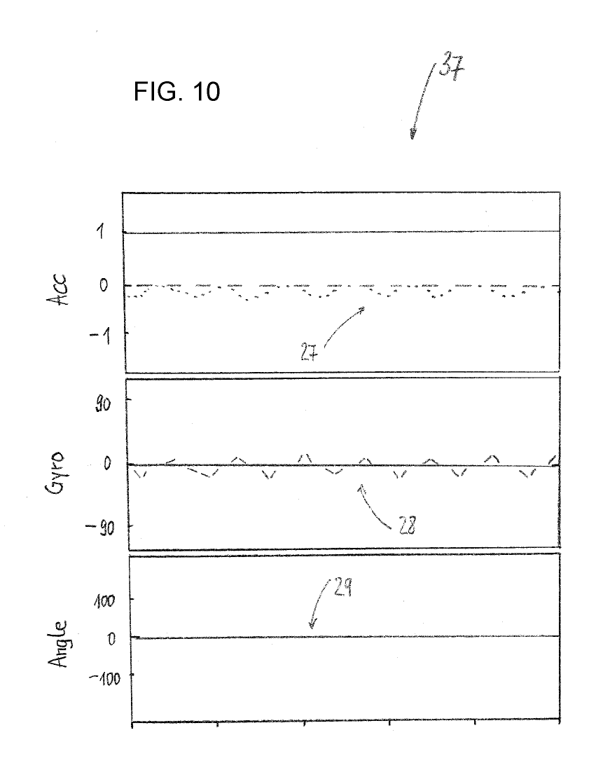

A seventh movement profile 37 in FIG. 10 shows a process in which the user actuates the seat inclination adjustment multiple times, with the backrest inclination blocked at the same time.

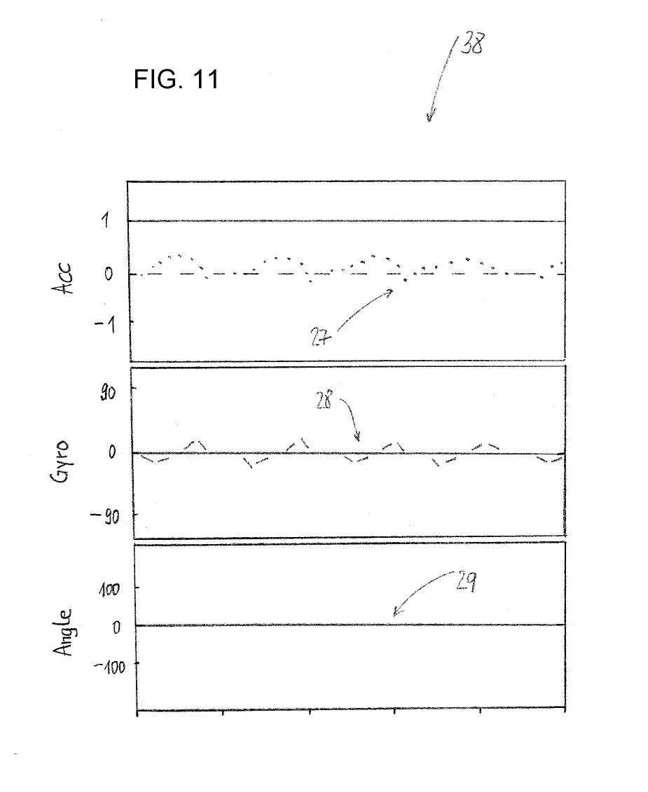

An eighth movement profile 38 in FIG. 11 shows a process in which the user actuates the backrest inclination adjustment multiple times, i.e. pivots the backrest forward and backward in the longitudinal direction 11 of the chair.

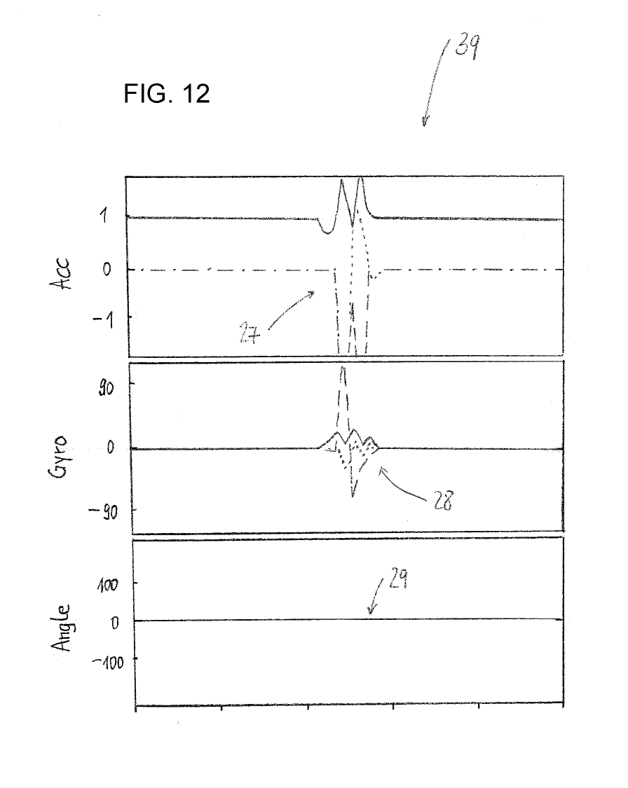

A ninth movement profile 39 in FIG. 12 shows a process in which the chair 1 falls onto the floor 7 from a height of approximately 0.5 m.

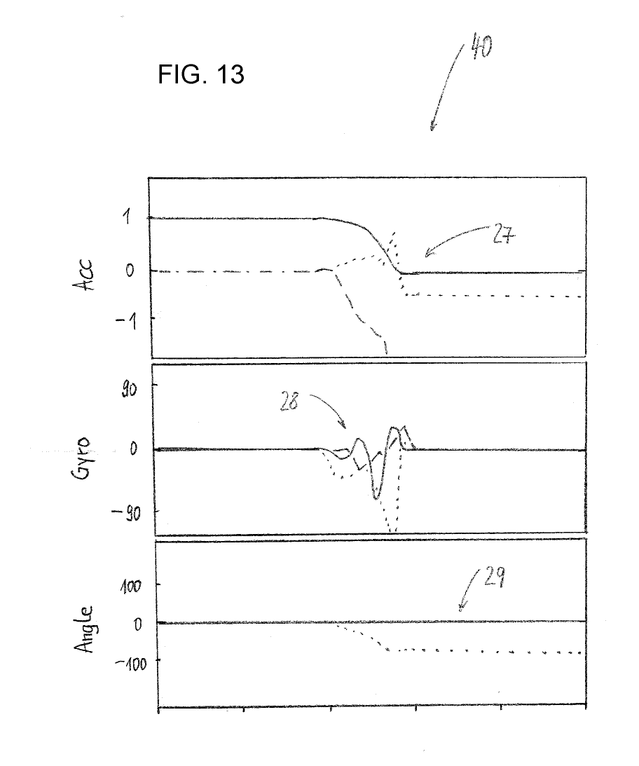

A tenth movement profile 40 in FIG. 13 shows a process in which the chair tilts through 90° about the X-axis and falls onto the floor 7.

The data processing device 24 provided for evaluating the data is now embodied in such a way that it subjects these movement profiles to pattern recognition, with the goal of identifying characteristic movement patterns of the entire chair 1 in the movement profiles or assigning such identified movement patterns to the movement profiles. By way of example, there is, for this purpose, a comparison of the movement profiles with certain comparison profiles which are preferably defined in advance and stored in a data storage device. To this end, the data processing device 24 includes suitable algorithms for pattern recognition. If characteristic movement patterns of the chair are identified, there may be appropriate counting, evaluation, etc. of the respective events. These events can subsequently be supplied to further data processing outside of, or within, the evaluation system 21 for the purposes of identifying vandalism and/or processing complaints.

Preferably, no exact placement of the IMU 12, for instance aligned to the axes of the chair coordinate system, is required during the assembly of the chair. Instead, the IMU 12 may be placed obliquely in space “in some way.” For most movement patterns to be identified, the placement of the IMU 12 plays no role or only a subordinate role. This means that, independently of the sensor placement, a reliable pattern recognition is possible. In other movement profiles, it may be advantageous for the purpose of simplifying or optimizing the comparison process during the identification of the characteristic movement patterns if the real measurement results of the IMU 12, which relate to the sensor coordinate system X′, Y′, Z′, are converted, for example immediately after the measurement or else immediately before the evaluation, into measurement results that relate to the chair coordinate system X, Y, Z in order to assist a reliable pattern recognition in a proceeding normalization step.

All features illustrated in the description, the following claims and the drawing may be important to the invention, both on their own and also combined in any combination.

The following is a summary list of reference numerals and the corresponding structure used in the above description of the invention. List of reference signs:
1 Chair
2 Base support
3 Conical receiving device
4 Chair column
5 Foot cross
6 Roller
7 Floor
8 Seat support
9 Backrest support
10 (free)
11 Longitudinal direction of the chair
12 Inertial measurement unit (IMU)
13 Acceleration sensors
14 Angular rate sensors
15 Vertical axis
16 Pivot axis of the seat
17 Pivot axis of the backrest
18 Data storage
19 Data processing device
20 (free)
21 Evaluation system
22 Receiving or reading device
23 Computer
24 Data processing device
25 Output device, data storage
26 Output device, screen
27 Acceleration
28 Angular speed
29 Angle of rotation
30 (free)
31 First movement profile
32 Second movement profile
33 Third movement profile
34 Fourth movement profile
35 Fifth movement profile
36 Sixth movement profile
37 Seventh movement profile
38 Eighth movement profile
39 Ninth movement profile
40 Tenth movement profile

1. A chair or office chair, comprising:
at least one sensor being positionally independent relative to the chair and configured to capture movement data of the chair;
said movement data being suitable for identifying characteristic movement patterns of the entire chair.

2. The chair according to claim 1, wherein said at least one sensor being positionally independent relative to the chair is at least one inertial measurement unit.

3. The chair according to claim 2, wherein said at least one inertial measurement unit has at least three acceleration sensors and at least three angular rate sensors.

4. The chair according to claim 2, which further comprises a storage device for recording said captured movement data, said storage device being connected to said at least one inertial measurement unit.

5. The chair according to claim 4, which further comprises a data processing device for processing said captured movement data, said data processing device being connected to at least one of said at least one inertial measurement unit or said storage device.

6. The chair according to claim 1, wherein said at least one sensor is connected to the chair in at least one of a tamperproof or vandalism-proof manner.

7. A method for capturing movement data of chair or office chair, the method comprising the following steps:
using at least one sensor being positionally independent relative to the chair to capture movement data being suitable for identifying characteristic movement patterns of the entire chair.

8. A system for evaluating movement data of a chair or office chair, the system comprising:
a receiving or reading device configured to receive data of the chair captured by using the chair according to claim 1;
a data processing device configured to evaluate said received data or to identify at least one of vandalism or processing complaints with respect to the chair; and
an output device configured to output a result of said data evaluation.

9. A system for evaluating movement data of a chair or office chair, the system comprising:
a receiving or reading device configured to receive data of the chair captured by using at least one sensor being positionally independent relative to the chair to capture movement data being suitable for identifying characteristic movement patterns of the entire chair;
a data processing device configured to evaluate said received data or to identify at least one of vandalism or processing complaints with respect to the chair; and
an output device configured to output a result of said data evaluation.

10. A method for evaluating movement data of a chair or office chair, the method comprising the following steps:
receiving data of the chair having been captured by using the chair according to claim 1;
evaluating the received data for identifying at least one of vandalism or processing complaints with respect to the chair; and
outputting a result of the data evaluation.

11. A method for evaluating movement data of a chair or office chair, the method comprising the following steps:
receiving data of the chair having been captured by using at least one sensor being positionally independent relative to the chair to capture the movement data being suitable for identifying characteristic movement patterns of the entire chair;
evaluating the received data for identifying at least one of vandalism or processing complaints with respect to the chair; and
outputting a result of said data evaluation.

12. The method according to claim 10, which further comprises carrying out the evaluation of the obtained data for creating movement profiles from the received data and comparing the movement profiles to characteristic movement patterns of the chair.

13. The method according to claim 11, which further comprises carrying out the evaluation of the obtained data for creating movement profiles from the received data and comparing the movement profiles to characteristic movement patterns of the chair.

14. A non-transitory computer-readable medium that when executed on a computing unit evaluates movement data of a chair or office chair, by carrying out the following steps:
receiving data of the chair having been captured by using at least one sensor being positionally independent relative to the chair to capture the movement data being suitable for identifying characteristic movement patterns of the entire chair;
evaluating the received data for identifying at least one of vandalism or processing complaints with respect to the chair; and
outputting a result of said data evaluation.
